(19) United States
(12) Patent Application Publication
(10) Pub. No.: US 2025/0264127 A1
(43) Pub. Date: Aug. 21, 2025

(54) Fastening Apparatus

(71) Applicant: Wen Yi, Shenzhen (CN)

(72) Inventor: Wen Yi, Shenzhen (CN)

(21) Appl. No.: 18/582,286

(22) Filed: Feb. 20, 2024

(51) Int. Cl. F16B 37/14

(52) U.S. Cl. CPC F16B 37/14

(57) ABSTRACT

A fastening apparatus includes a thumbnut. The thumbnut comprises a body, a cap, and a first fastening mechanism. The body defines a top side, a bottom side, and an outer wall between the top side and the bottom side. The body is hollow to form an interior compartment. The top side of the body being an open side. The cap is configured to enclose the top side of the body. The first fastening mechanism is provided on the bottom side of the body.

### FIELD OF THE INVENTION

The present invention relates generally to fastening apparatuses. More specifically, the present invention is a fastening apparatus for welding helmets. The present invention is specifically designed for welding hoods. However, the present invention is not limited to this option, and it may further be adapted for different purposes.

### BACKGROUND OF THE INVENTION

Welding is an important process in the manufacture and construction of various products and structures. Applications for welding are widespread and used throughout the world, for example, the construction and repair of ships, buildings, bridges, vehicles, and pipelines. Traditionally, a user wears a conventional welding helmet with a face shield and a head harness. The face shield comprises a window with one or more protective lenses to reduce the intensity of the radiation to safe levels. The face shield is attached to the head harness by two pivot mechanisms such that the face shield may be raised out of view of the welder when not in use and lowered prior to the welder performing welding operations.

However, there are some drawbacks with the existing pivot mechanisms. For example, the existing pivot mechanisms are usually difficult to install and use. Moreover, the pivot mechanisms are usually made of heavy materials, such as metal, adding discomfort to the wearer.

Therefore, it is an objective of the present invention to provide a new fastening apparatus that overcomes the problems set forth above.

### SUMMARY OF THE INVENTION

The present invention discloses a fastening apparatus comprising a thumbnut. The thumbnut comprises a body, a cap, and a first fastening mechanism. The body defines a top side, a bottom side, and an outer wall between the top side and the bottom side. The body is hollow to form an interior compartment. The top side of the body being an open side. The cap is configured to enclose the top side of the body. The first fastening mechanism is provided on the bottom side of the body.

In one embodiment, the body is a cylindric body.

In one embodiment, the body further comprises a bottom surface at the bottom side, and the bottom surface comprises an annular groove.

In one embodiment, the fastening apparatus further comprises a washer that is configured to be received in the annular groove.

In one embodiment, the outer wall is a knurled outer wall.

In one embodiment, the fastening apparatus further comprises a fastening member, the fastening member comprising a head portion and a second fastening mechanism, the second fastening mechanism being configured to cooperate with the first fastening mechanism to releasably attach the fastening member to the thumbnut.

In one embodiment, the fastening member further comprises a square portion between the second fastening mechanism and the head portion.

In one embodiment, the first fastening mechanism is a threaded hole, while the second fastening mechanism is a threaded shank.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the thumbnut of the present invention.

FIG. 2 depicts a perspective view of the thumbnut of the present invention, wherein the cap is detached from the body of the thumbnut.

FIG. 3 depicts a front view of the thumbnut of the present invention.

FIG. 4 depicts a cross-sectional view of the thumbnut of the present invention, taken along the line A-A in FIG. 3.

FIG. 5 depicts a top view of the thumbnut of the present invention.

FIG. 6 depicts a bottom view of the thumbnut of the present invention.

FIG. 7 depicts a perspective view of the present invention.

FIG. 8 depicts another perspective view of the present invention.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of fastening apparatuses, embodiments of the present disclosure are not limited to use only in this context.

The present invention is a fastening apparatus that is specifically designed for welding helmets. It is an aim of the present invention to provide a fastening apparatus that allows a user to easily install the face shield to the head harness. It is another aim of the present invention to provide a lightweight fastening apparatus that is simple in structure and inexpensive to manufacture.

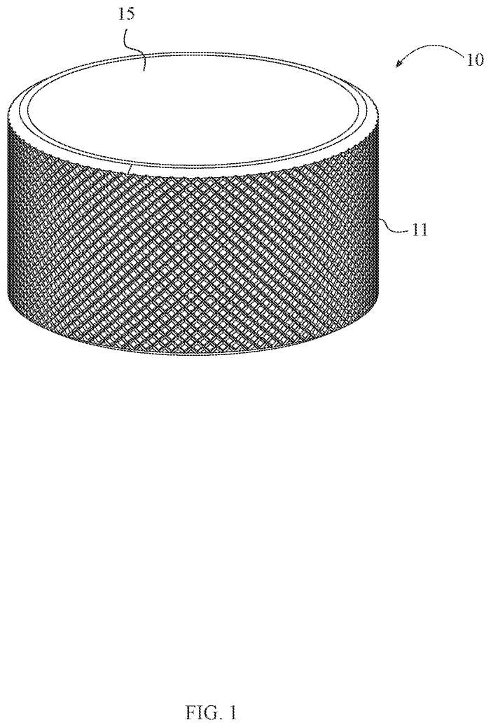

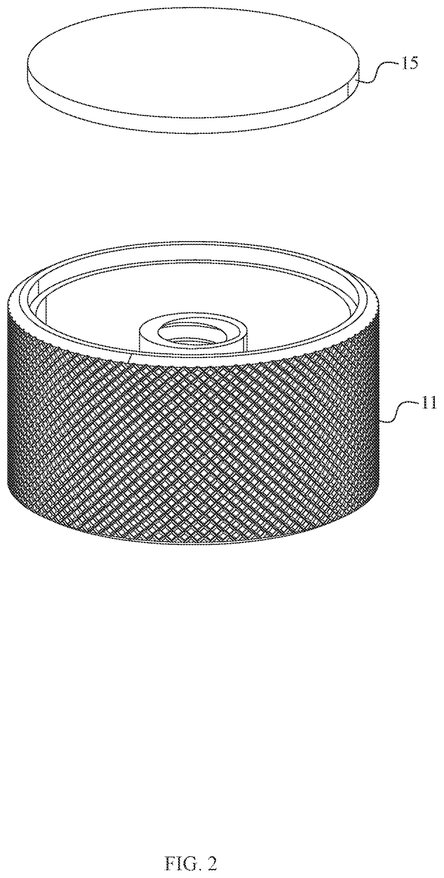

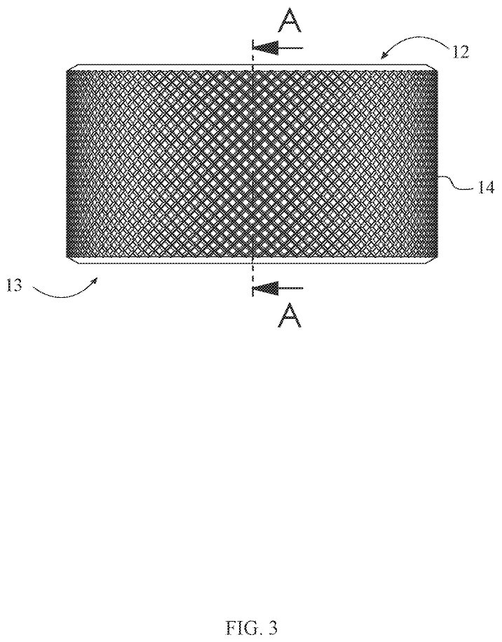

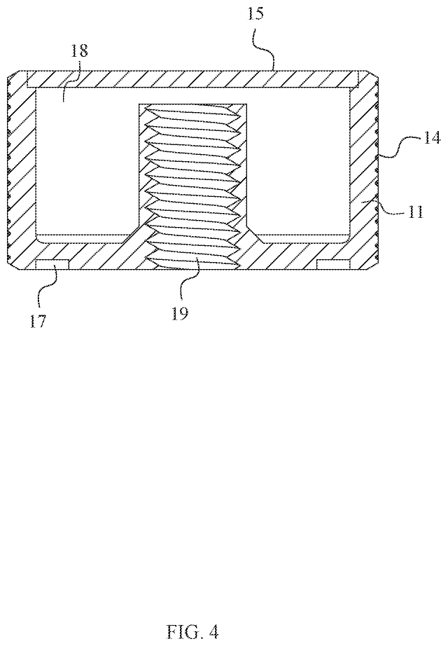

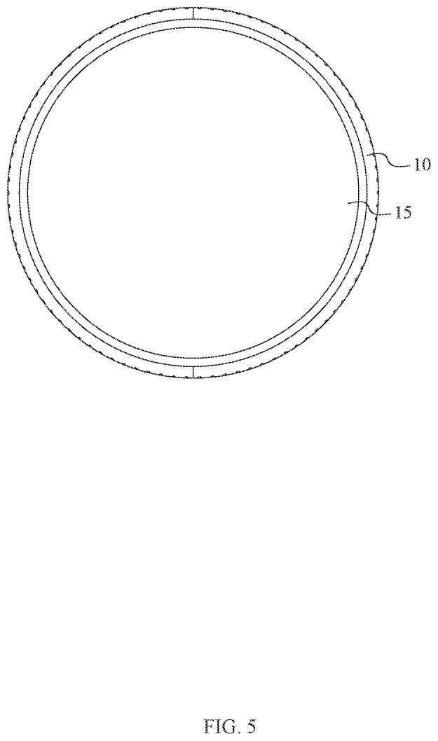

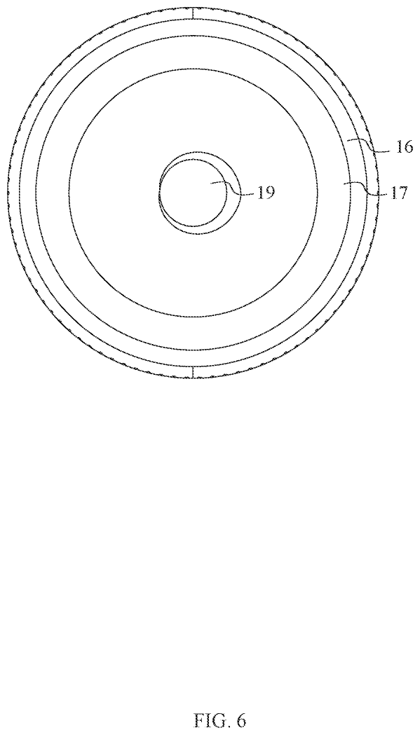

Referring now to the figures of the present disclosure. FIG. 1 is a perspective view illustrating the components of the present invention. The cleaning apparatus of the present invention comprises a thumbnut 10. It should be noted that the thumbnut 10 can be of any shape, size, material, features, type or kind, orientation, location, quantity, components, and arrangements of components that would allow the present invention to fulfill the objectives and intents of the present invention. In one embodiment, the thumbnut 10 comprises a body 11, a cap 15, and a first fastening mechanism 19. As shown in FIGS. 1-6. The body 1 defines a top side 12, a bottom side 13, and an outer wall 14 between the top side 12 and the bottom side 13. The body 11 is hollow to form an interior compartment 18. Although the interior compartment 18 illustrated in the drawings is an annular compartment, it should be noted that the interior compartment 18 may be of any shape. The interior compartment 18 will significantly reduce the overall weight of the fastening apparatus while maintaining the structural integrity thereof. The top side 12 of the body 11 is an open side. The cap 15 is configured to enclose the top side 12 of the body 11. The first fastening mechanism 19 is provided on the bottom side 13 of the body 11 for engagement with another fastening mechanism. In a preferred embodiment, the body 11 is a cylindric body. Further, the body 11 may comprise a bottom surface 16 at the bottom side 13. In a preferred embodiment, the bottom surface 16 comprises an annular groove 17. A washer 30 may be configured to be received in the annular groove 17. Preferably, the washer 30 is a silicone washer that facilitates tight engagement of the fastening mechanisms. In one embodiment, the outer wall 14 may be a knurled outer wall to assist in enabling the user to grasp and turn the thumbnut 10 by hand.

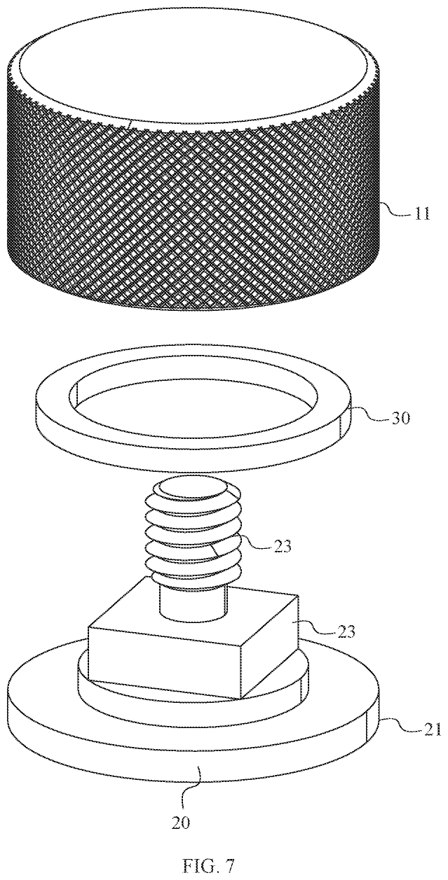

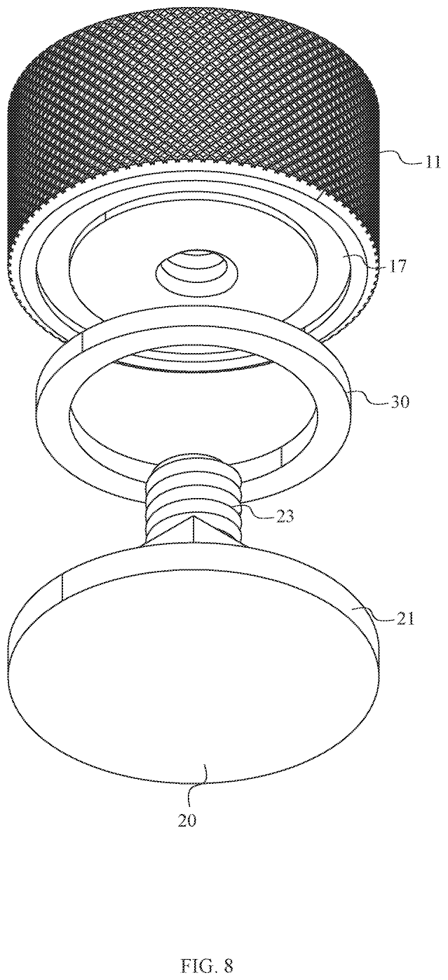

In one embodiment, the present invention further comprises a fastening member 20, as shown in FIGS. 7-8. The fastening member 20 is configured to attach to the thumbnut 10. It should be noted that the fastening member 20 can be of any shape, size, material, features, type or kind, orientation, location, quantity, components, and arrangements of components that would allow the present invention to fulfill the objectives and intents of the present invention. The fastening member may comprise a head portion 21 and a second fastening mechanism 23. the second fastening mechanism 23 is configured to cooperate with the first fastening mechanism 19 to releasably attach the fastening member 20 to the thumbnut 10. In a preferred embodiment, the fastening member 20 further comprises a square portion 20 between the second fastening mechanism 23 and the head portion 21. The square portion 20 may fit in a corresponding square hole in the head harness to prevent the fastening member 20 from rotating when the user turns the thumbnut 10. In the illustrated embodiment, the first fastening mechanism 19 is a threaded hole, while the second fastening mechanism 23 is a threaded shank. However, it should be noted that other fastening methods can also be used, such as welding, brazing, bonding, adhesive or other mechanical fasteners.

The present invention may be made of any suitable material, preferably but not limited to thermoplastic material or be made of metals such as aluminum or any other suitable materials or using any suitable combination thereof. It should be understood that the components of the present invention may or may not be made of the same material. Further, it is envisioned that the sizes of the components forming the present invention such as the thumb nut 10 and/or the fastening member 20 can vary based on design requirements.

Although the disclosure has been explained in relation to its preferred embodiment, it is to be understood that many other possible modifications and variations can be made without departing from the spirit and scope of the disclosure.

what is claimed is:

1. A fastening apparatus comprising:
a thumbnut;
the thumbnut comprising a body, a cap, and a first fastening mechanism;
the body defining a top side, a bottom side, and an outer wall between the top side and the bottom side;
the body being hollow to form an interior compartment;
the top side of the body being an open side;
the cap being configured to enclose the top side of the body;
the first fastening mechanism being provided on the bottom side of the body.

2. The fastening apparatus as claimed in claim 1, wherein the body is a cylindric body.

3. The fastening apparatus as claimed in claim 2, wherein the body further comprises a bottom surface at the bottom side, and the bottom surface comprises an annular groove.

4. The fastening apparatus as claimed in claim 3, further comprising a washer that is configured to be received in the annular groove.

5. The fastening apparatus as claimed in claim 1, wherein the outer wall is a knurled outer wall.

6. The fastening apparatus as claimed in claim 1, further comprising a fastening member, the fastening member comprising a head portion and a second fastening mechanism, the second fastening mechanism being configured to cooperate with the first fastening mechanism to releasably attach the fastening member to the thumbnut.

7. The fastening apparatus as claimed in claim 6, wherein the fastening member further comprises a square portion between the second fastening mechanism and the head portion.

8. The fastening apparatus as claimed in claim 6, wherein the first fastening mechanism is a threaded hole, while the second fastening mechanism is a threaded shank.
